(19) United States
(12) Patent Application Publication
(10) Pub. No.: US 2026/0287822 A1
(43) Pub. Date: Sep. 24, 2026

(54) METHOD FOR FABRICATING OPTICAL DEVICE STRUCTURES

(71) Applicant: Applied Materials, Inc., Santa Clara, CA (US)

(72) Inventors: Wenhui WANG, San Jose, CA (US); Lei JIANG, San Ramon, CA (US); Yongan XU, Santa Clara, CA (US); Zefang WANG, Santa Clara, CA (US)

(21) Appl. No.: 19/490,045

(22) PCT Filed: Jun. 25, 2024
(86) PCT No.: PCT/US2024/035460

§ 371 Date: Dec. 4, 2025

Related U.S. Application Data
(60) Provisional application No. 63/510,502, filed on Jun. 27, 2023.

(51) Int. Cl. G02B 6/34; G02B 27/01

(52) U.S. Cl. CPC G02B 6/34; G02B 27/0172

(57) ABSTRACT

Methods and apparatus for forming waveguides. One example waveguide generally includes a substrate, a first device layer disposed over a first surface of the substrate, a second device layer disposed over a second surface of the substrate, a first grating disposed over the first device layer, the first grating comprising a plurality of first blazed device structures arranged in a first direction, and a second grating disposed over the second device layer. Each first blazed device structure generally includes a plurality of steps, a facet normal of each of the plurality of steps parallel to a primary surface of the first device layer, and a blaze angle defined by a blazed surface and the facet normal. The second grating generally includes a plurality of second blazed device structures arranged in a second direction, where the second direction is different than the first direction.

### BACKGROUND

### Field

Embodiments of the present disclosure generally relate to optical devices for augmented, virtual, and mixed reality. More specifically, embodiments described herein provide for forming blazed optical device structures.

### Description of the Related Art

Virtual reality is generally considered to be a computer-generated simulated environment in which a user has an apparent physical presence. A virtual reality experience can be generated in three dimensions and viewed with a head-mounted display (HMD), such as glasses or other wearable display devices that have near-eye display panels as lenses to display a virtual reality environment that replaces the actual environment.

Augmented reality, however, enables an experience in which a user can still see through the display lenses of the glasses or other HMD device to view the surrounding environment, yet also see images of virtual objects that are generated in the display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners, and flat optical devices, such as metasurfaces, are used to assist in overlaying images. Generated light is propagated through an optical device until the light exits the optical device and is overlaid on the ambient environment. Optical devices may use structures having blazed angles relative to the surface of the optical device substrate. Fabricating efficient blazed optical device structures can be challenging due to manufacturing difficulties.

Accordingly, what is desired in the art are improved methods of forming optical devices which include efficient blazed optical device structures.

### SUMMARY

Embodiments of the present disclosure are directed to a waveguide. The waveguide generally includes a substrate, a first device layer disposed over a first surface of the substrate, a second device layer disposed over a second surface of the substrate, a first grating disposed over the first device layer, the first grating comprising a plurality of first blazed device structures arranged in a first direction, and a second grating disposed over the second device layer. Each first blazed device structure generally includes a plurality of steps, a facet normal of each of the steps parallel to a primary surface of the first device layer, and a blaze angle defined by a blazed surface and the facet normal. The second grating generally includes a plurality of second blazed device structures arranged in a second direction, where the second direction is different than the first direction.

Embodiments of the present disclosure provide a method. The method generally includes (i) patterning a first hardmask layer over a first device layer, the first hardmask layer exposing first segments of the first device layer and being disposed over second segments of the first device layer, where the first segments of the first device layer correspond to initial blazed device structures to be formed and the second segments of the first device layer correspond to subsequent blazed device structures to be formed, (ii) disposing a first resist material over the first hardmask layer and the first device layer (iii) performing a staircase process for the first segments of the first device layer to form the first segments of the waveguide, the first segments having first blazed device structures, where each of the first blazed device structures include a plurality of steps, and (iv) performing the staircase process for first segments of a second device layer, the first segments of the second device layer having second blazed device structures, where each of the second blazed device structures include a plurality of steps, where the first device layer is disposed over a first surface of a substrate, where the second device layer is disposed over a second surface of the substrate, and where the second surface is opposite to the first surface.

Embodiments of the present disclosure provide a method. The method generally includes (i) patterning a first hardmask layer over a waveguide material, the first hardmask layer exposing first segments of the waveguide material and being disposed over second segments of the waveguide material, where the first segments of the waveguide material correspond to initial blazed device structures to be formed and the second segments of the waveguide material correspond to subsequent blazed device structures to be formed, (ii) disposing a first resist material over the first hardmask layer and the waveguide material, (iii) performing a staircase process for the first segments to form the first segments of the waveguide, the first segments having first blazed device structures, (iv) removing the first resist material, disposing a second hardmask layer over the first blazed device structures, and removing the first hardmask layer, the second hardmask layer exposing second segments of the waveguide material after the first hardmask layer is removed, (v) disposing a second resist material over the second hardmask layer and the waveguide material, and (vi) performing the staircase process for the second segments, the second segments having second blazed device structures.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1A is a perspective, frontal view of a waveguide according to embodiments described herein.

FIGS. 1B-1D are a schematic side cross-sectional views of device structures of a waveguide, according to embodiments described herein.

FIG. 2 is a flow diagram illustrating an example method for fabricating blazed device structures, according to one or more of the embodiments described herein.

FIGS. 3A-3N are schematic side cross-sectional views of a substrate during fabrication of a blazed device structure, according to one or more of the embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure provided herein include a method of fabricating blazed device structures. In some embodiments, fabricating the blazed device structures includes performing a staircase process multiple times, each staircase process including multiple lithographic patterning steps and multiple timed etch steps. Fabricating the blazed device structures may include disposing a hardmask layer over first segments of waveguide material (e.g., a substrate or device layer) after performing the staircase process on the first segments and before performing the staircase process on second segments of the substrate. In some embodiments, the fabrication of blazed device structures includes some operations similar to those used during the fabrication of a 3D NAND device, which enables a fast and more established fabrication process. According to certain embodiments, the blazed device structures may be fabricated on both sides of the waveguide material.

Some methods for fabricating blazed device structures often do not include performing a staircase process multiple times using a hardmask layer disposed after the first iteration of the staircase process has been performed, which results in blazed device structures with a top and/or bottom having a flat surface (e.g., without sharp tips and corners). As a result, some blazed device structures have a diminished efficiency, which is undesirable for many augmented, virtual, and mixed reality applications. Embodiments of the present disclosure may provide a method of fabricating blazed device structures where the initial depth of the plurality of depths in first segments is adjacent to a final depth of a plurality of depths in the second segments. The initial depth of the first segments adjacent to the final depth of the second segments provide for blazed device structures having sharp tips and corners with more blazed steps. The initial depth of the first segments adjacent to the final depth of the second segments results in a greater efficiency for the blazed device structures.

### Example Waveguide

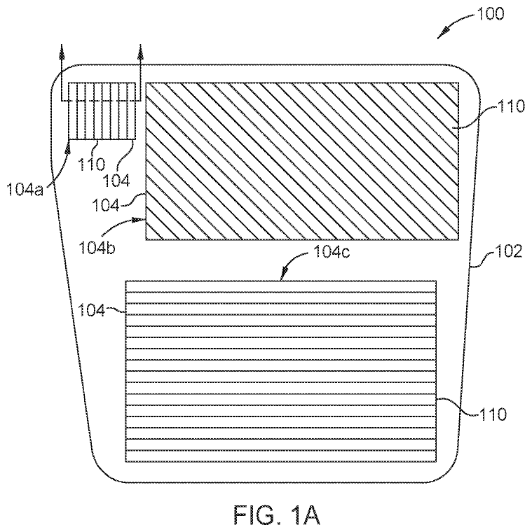

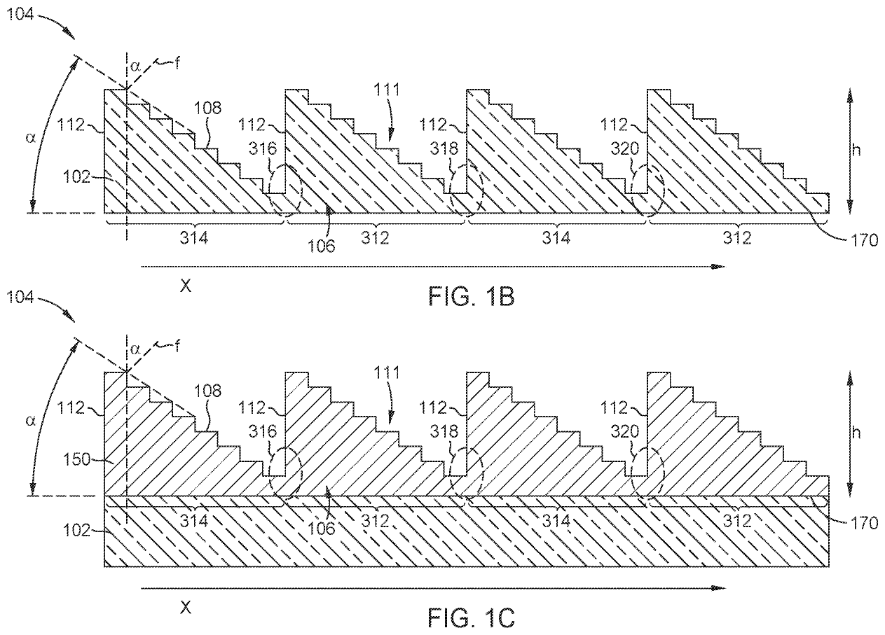

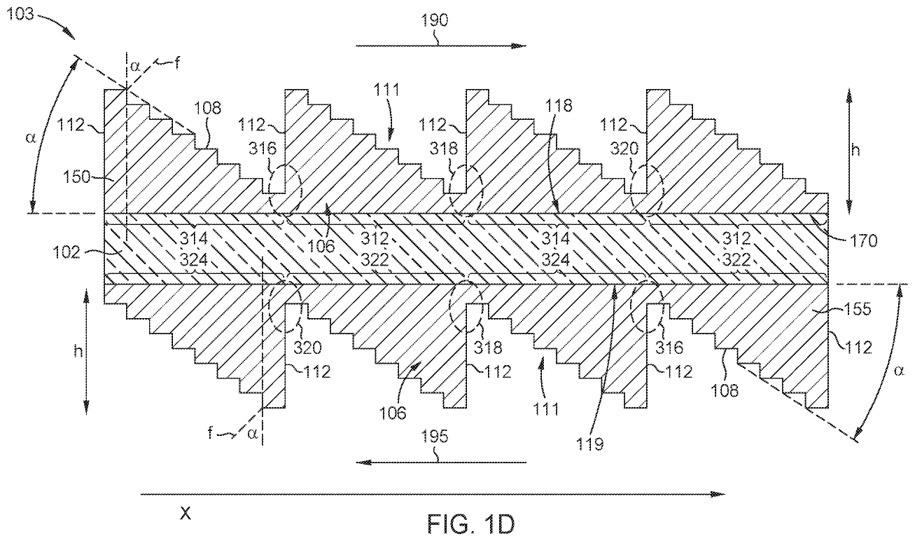

FIG. 1A illustrates a perspective, frontal view of a waveguide 100, according to embodiments described herein. It is to be understood that the waveguide 100 described below is an exemplary optical device. The waveguide 100 may be implemented as a single-sided waveguide (as shown in FIGS. 1B and 1C) or a double sided waveguide (as shown in FIG. 1D). In some embodiments, the waveguide 100 is a waveguide combiner, such as an augmented reality waveguide combiner. The waveguide 100 includes a plurality of grating structures 110 disposed in (as shown in FIG. 1B) or on (as shown in FIG. 1C) a substrate 102 (e.g., a waveguide substrate, hereinafter referred to as “substrate 102”). The waveguide 100 may also include a plurality of grating structures 110 disposed on two sides of a substrate 102 (as shown in FIG. 1D). The grating structures 110 are nanostructures having sub-micron dimensions, e.g., nano-sized dimensions, such as critical dimensions less than 1 μm. In some embodiments, regions of the grating structures 110 of the waveguide 100 correspond to one or more gratings 104, such as a first grating 104a, a second grating 104b, and a third grating 104c, as illustrated. In some embodiments, the at least the first grating 104a corresponds to an input coupling grating and the third grating 104c corresponds to an output coupling grating. The waveguide 100 may also include the second grating 104b corresponding to an intermediate grating. The one or more gratings 104 may each include one or more grating structures 110.

### Example Waveguide Formation and Structure With Variable Depth

FIG. 1B is a schematic side cross-sectional view of a grating 104 of a waveguide 100, according to embodiments described herein. The substrate 102 includes a plurality of grating structures 110 disposed therein. In some embodiments, the grating structures 110 are blazed device structures 106 of a flat optical device, such as a metasurface. In some embodiments, the grating structures 110 are blazed device structures 106 of a waveguide combiner, such as an augmented reality waveguide combiner. The waveguide combiner may include blazed device structures 106 in at least one of the gratings 104. Each of the blazed device structures 106 includes a blazed surface 108, a sidewall 112, and a depth h. The blazed surface 108 has a plurality of steps 111. In some embodiments, the blazed surface 108 includes at least 7 steps 111, as illustrated. The depth h corresponds to the height of the sidewall 112. In some embodiments, the blazed surface 108 of each of the blazed device structures 106 include an equal quantity of steps, as illustrated in FIGS. 1B and 1C. In other embodiments, the blazed surface 108 of each of the blazed device structures 106 include a different quantity of steps.

The blazed device structures 106 may be formed on first segments 312 and second segments 314 of the substrate 102, as illustrated. The first segments 312 may correspond to the distances between sidewalls 112 of adjacent blazed device structures 106. The second segments 314 may also correspond to the distances between sidewalls 112 of adjacent blazed device structures 106. For example, one of the first segments 312 may correspond to one of the blazed device structures 106, and one of second segments 314 may correspond to another of the blazed device structures 106, as illustrated. In some embodiments, the depth h of two or more blazed device structures 106 are different. In other embodiments, the depth h of two or more blazed device structures 106 are the same. The length of the first segments 312 and second segments 314 may be the same, or different. The plurality of the blazed surface 108 may be parallel to a primary surface 170 of the substrate 102, as illustrated. The grating structures 110 may include a facet normal f of each of the steps parallel to the primary surface 170 of the substrate 102. The grating structures 110 may each have a blaze angle a defined by the blazed surface 108 and the facet normal f.

The substrate 102 may be selected to transmit a suitable amount of light of a desired wavelength or wavelength range, such as one or more wavelengths from about 100 to about 3000 nanometers (nm). The substrate 102 may be configured such that the substrate 102 transmits greater than or equal to about 50% to about 100% of an infrared radiation (IR) to ultraviolet (UV) region of the light spectrum. The substrate 102 may be formed from any suitable material, provided that the substrate 102 can adequately transmit light in a desired wavelength or wavelength range. Substrate 102 selection may include substrates of any suitable material, including, but not limited to, amorphous dielectrics, non-amorphous dielectrics, crystalline dielectrics, silicon oxide, polymers, and combinations thereof. In some embodiments, the substrate 102 includes a transparent material. Suitable examples may include an oxide, sulfide, phosphide, telluride or combinations thereof. In one example, the substrate 102 includes silicon (Si), silicon dioxide (SiO₂), silicon nitride (Si₃N₄), germanium (Ge), silicon germanium (SiGe), sapphire, and high-index transparent materials such as high-refractive-index glass. In some embodiments, the transparent material included in the substrate 102 may be doped.

The substrate 102 may be selected from any suitable material, provided the substrate 102 can adequately transmit a suitable amount of light of a desired wavelength or wavelength range, such as one or more wavelengths from about 380 nm to about 700 nm. The substrate 102 can include waveguides of any suitable material, including but not limited to, amorphous dielectrics, non-amorphous dielectrics, crystalline dielectrics, silicon oxide, polymers, transparent materials, or any combinations thereof. Suitable examples may include, but are not limited to, an oxide, sulfide, phosphide, telluride, nitride, carbide, or combinations thereof. In one example, the substrate 102 includes lithium niobate (LiNb03), silicon dioxide (SiO₂), titanium (II) oxide (TiO) fused silica, quartz, sapphire, and high-index transparent materials such as glass, or combinations thereof. In some embodiments, the material of the substrate 102 includes materials having a refractive index between about 1.0 and 5.0, such as between about 1.7 and about 2.8.

FIG. 1C is a cross-sectional view of a grating 104 of a waveguide 100, according to one or more of the embodiments described herein. The waveguide 100 of FIG. 1C may be similar to the waveguide 100 of FIG. 1B, but the plurality of grating structures 110 may disposed in a device layer 150 (e.g., in device material) instead of the substrate 102, as illustrated. In the waveguide 100, the device layer 150 (which includes the grating structures 110) may be disposed over the substrate 102. In some embodiments, the device layer 150 may not be used in the waveguide 100 and the substrate 102 may be included in and/or referred to as waveguide material. In other embodiments, the device layer 150 may be used in the waveguide 100 and may be disposed over the substrate 102, and the device layer 150 and the substrate 102 may together be included in and/or referred to as waveguide material.

In some embodiments, the device layer 150 may include one or more of titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), or cadmium stannate (Cd₂SnO₄). In some embodiments, the material of the device layer 150 may have a refractive index between about 1.0 and 5.0, such between about 1.5 and about 2.65. In other embodiments, the material of the device layer 150 may have a refractive index between about 1.0 and 5.0, such as between about 3.5 and about 4.0.

FIG. 1D is a cross-sectional view of a grating 103 of a waveguide 100, according to one or more of the embodiments described herein. The waveguide 100 of FIG. 1D may be similar to the waveguide 100 of FIG. 1B, but the plurality of grating structures 110 may disposed in device layer 150 (which may be referred to as a “first device layer”) and in device layer 155 (which may be referred to as a “second device layer”) instead of the substrate 102, as illustrated. In the waveguide 100, the device layer 150 (which includes the grating structures 110) may be disposed over a first surface 118 of the substrate 102 and the device layer 155 may be disposed over a second surface 119 of the substrate 102, as illustrated in FIG. 1D. In these embodiments, the first surface 118 of the substrate 102 may be opposite to the second surface 119 of the substrate 102, also as illustrated. As described above, the grating structures 110 may be blazed device structures 106. One or more of the blazed device structures 106 may be arranged in a first direction in the device layer 150 (e.g., in the direction 190, which is the positive X-direction, as illustrated in FIG. 1D), and one or more of the blazed device structures 106 may be arranged in a second direction in the device layer 155 (e.g., in the direction 195, which is the negative X-direction, as illustrated in FIG. 1D). I.e., the blazed device structures 106 of the grating 104 and the blazed device structures 106 of the grating 104 may be asymmetric on opposing sides of the substrate 102. In some cases, the second direction may be at a 180 degree angle to the first direction, as illustrated.

In some embodiments, the blaze angle a defined by the blazed surface 108 and the facet normal f of the grating structures 110 in device layer 150 may be vertically opposite to the blaze angle a defined by the blazed surface 108 and the facet normal f of the grating structures 110 in device layer 155 may be vertically opposite, as illustrated in FIG. 1D.

The method 200 described herein may enable blazed device structures 106 where the initial depth of the plurality of depths in the first segments 312 is adjacent to a final depth of a plurality of depths in the second segments 314, as illustrated at locations 316, 318, 320 in FIGS. 1B and 1C.

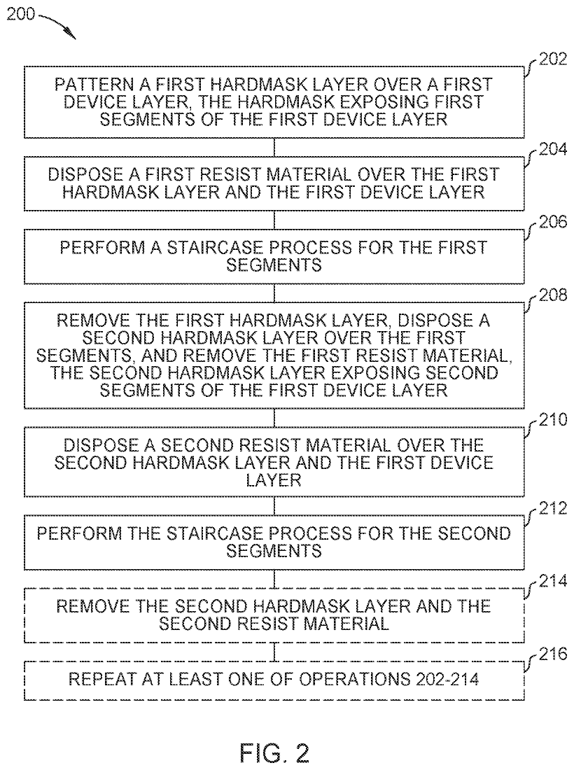

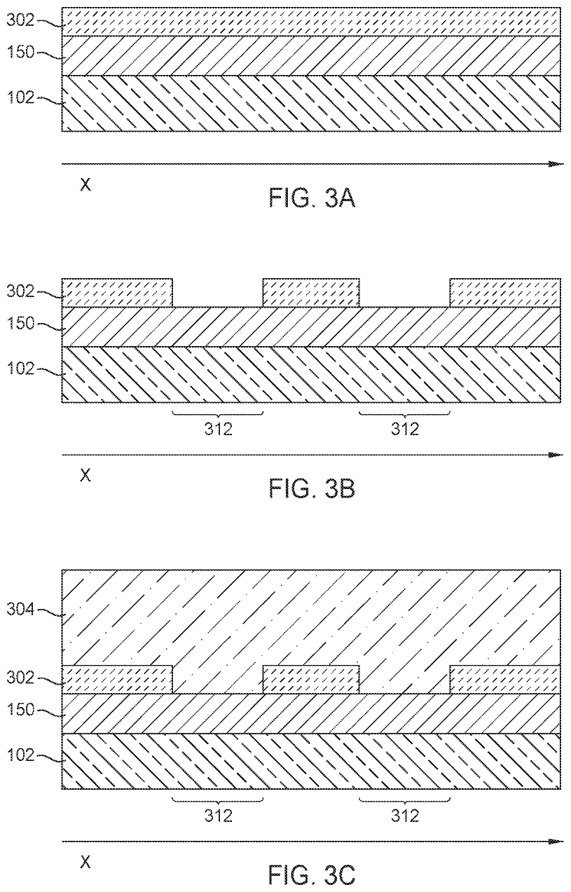

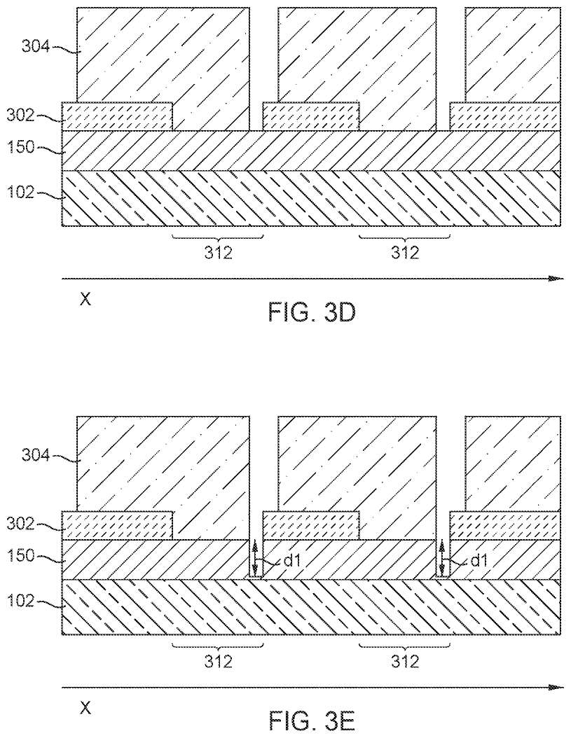

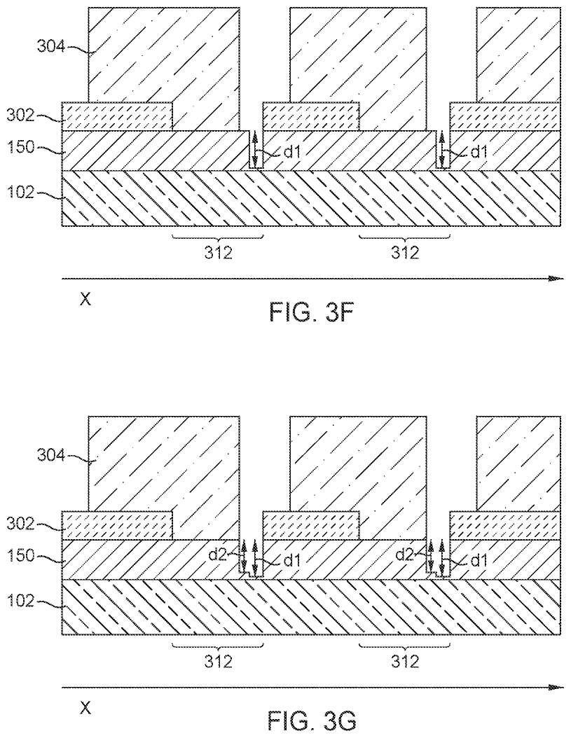

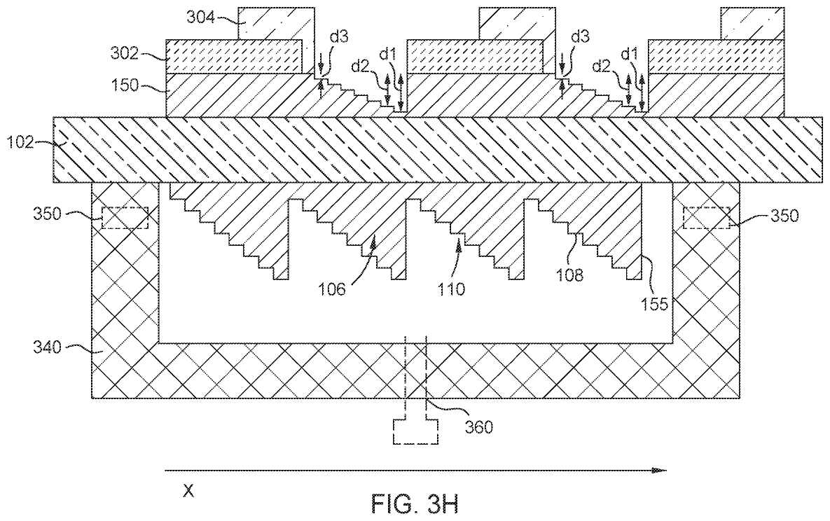

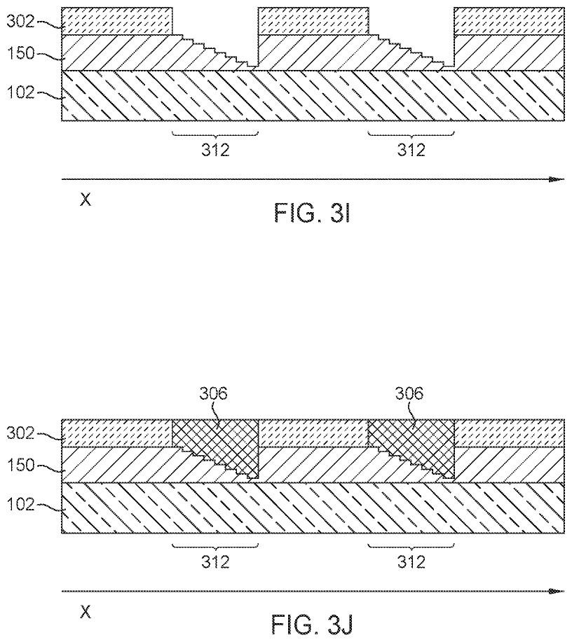

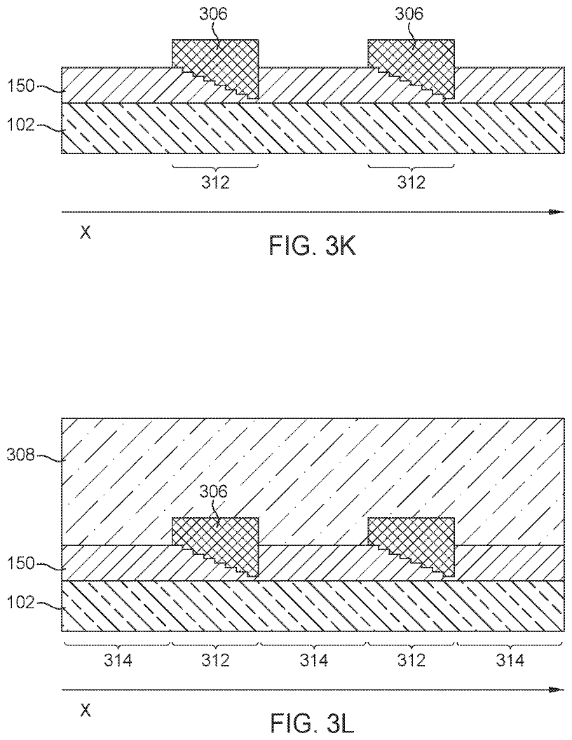

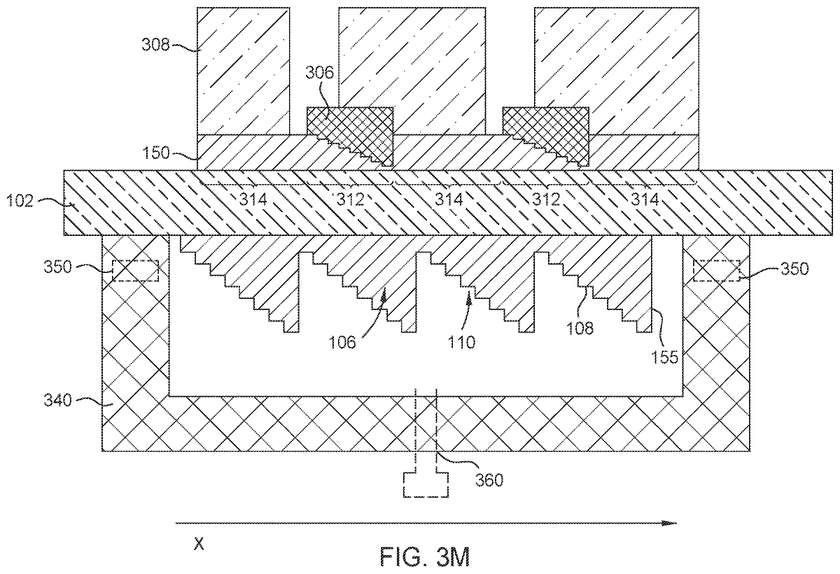

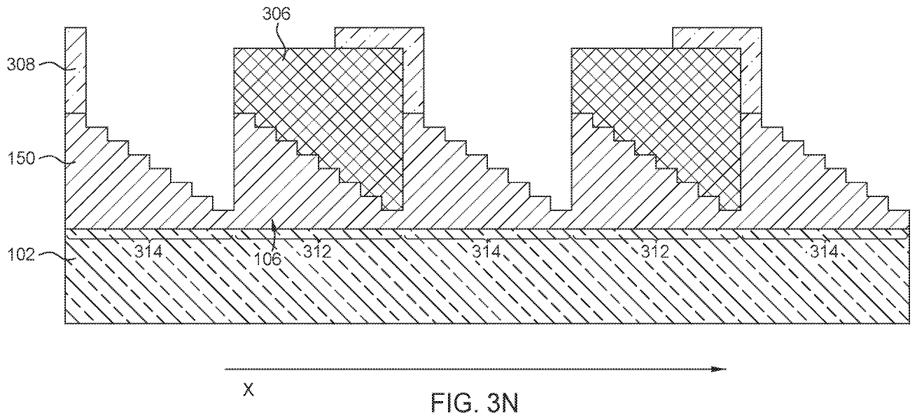

FIG. 2 is a flow diagram illustrating a method 200 for fabricating a plurality of blazed device structures 106, according to one or more of the embodiments described herein. FIGS. 3A-3N are schematic side cross-sectional views of the waveguide material and the device layer 150 during fabrication of a plurality of blazed device structures 106 during one or more of the operations illustrated in FIG. 2, according to one or more of the embodiments described herein. Therefore, FIG. 2 and FIGS. 3A-3N are herein described together for clarity. It is assumed that the first hardmask layer 302 and the device layer 150 were previously disposed over the waveguide material. In some embodiments, the methodology used in method 200 may be substantially similar to the methodology used to fabricate a 3D NAND device and create a word line staircase. The method 200 may include performing a staircase process multiple times (e.g., operations 206, 212) using a hardmask layer (e.g., second hardmask layer 306) disposed after the first iteration of the staircase process has been performed, which results in blazed structures (e.g., blazed device structures 106) with a top and/or bottom having a flat surface (e.g., without sharp tips and corners). The method 200 may not utilize an etch stop layer and the accompanying process operations, which are common in 3D NAND fabrication. In some embodiments, the method 200 may be performed first on a first surface of the substrate 102 and subsequently on a second surface of the substrate 102 (e.g., as illustrated in FIGS. 3H and 3M, which are described below).

In some embodiments, the first hardmask layer 302 may be disposed over the substrate 102 by one or more of physical vapor deposition (PVD), chemical vapor deposition (CVD), plasma-enhanced (PECVD), flowable CVD (FCVD), atomic layer deposition (ALD), and spin-on processes. In some embodiments, the first hardmask layer 302 includes one or more of chromium (Cr), tungsten (W), tungsten carbide (WC), ruthenium (Ru), silicon nitride (SiN), and silicon oxide (SiOₓ), titanium nitride (TiN), and carbon (C) containing materials.

The method 200 may include, at operation 202, patterning a first hardmask layer 302 over the waveguide material, the first hardmask layer 302 exposing first segments 312 of the waveguide material. As described above, the waveguide material may include, for example the substrate 102, the substrate 102 and the device layer 150, or the substrate 102, the device layer 150, and the device layer 155. The first segments 312 of the device layer 150 may correspond to initial blazed device structures 106 to be formed and the second segments of the device layer 150 may correspond to subsequent blazed device structures 106 to be formed. Each first segment of the first segments 312 of the device layer 150 may be adjacent to each second segment of the second segments 314 of the device layer 150.

Patterning the first hardmask layer 302 may involve depositing a resist material over the first hardmask layer 302, as illustrated in FIG. 3A. Patterning the first hardmask layer 302 may also involve patterning the resist material to expose segments of the first hardmask layer 302, and then etching the exposed segments of the first hardmask layer 302, as illustrated in FIG. 3B. In some cases, the resist material is selected based on the first hardmask layer 302 etch chemistry.

In some embodiments, the resist material may be a single layer resist or a multi-layer resist. For example, the resist material may be a tri-layer lithography stack (e.g., including an organic planarization layer, a bottom anti-reflection layer and resist), a bi-layer lithography stack (e.g., including a bottom reflection layer +resist, top reflection layer +resist), or other layers. In some embodiments, the resist material may be a four layer lithography stack. In one example, when the resist material is a multi-layer resist, patterning the resist material may include transferring the pattern to the lower layers inside the multi-layer resist before etching the first hardmask layer 302. In this example, the resist material is not selected based on the first hardmask layer 302 etch chemistry. In some embodiments, the etching includes using a reactive ion etch (RIE) process.

The method 200 may generally include, at operation 204, disposing a first resist material 304 over the first hardmask layer 302 and the waveguide material, as illustrated in FIG. 3C. The first resist material 304 may include a photoresist material. The photoresist material may include light-sensitive polymer containing materials. In some cases, the first resist material 304 is selected based on the waveguide material etch chemistry.

In some embodiments, the first resist material 304 may be a single layer resist or a multi-layer resist. For example, the first resist material 304 may be a tri-layer lithography stack (e.g., including an organic planarization layer, a bottom anti-reflection layer and resist), a bi-layer lithography stack (e.g., including a bottom reflection layer+resist, top reflection layer+resist), or other layers. In some embodiments, the first resist material 304 may be a four layer lithography stack. In one example, when the first resist material 304 is a multi-layer resist, patterning the first resist material 304 may include transferring the pattern to the lower layers inside the multi-layer resist before etching the first hardmask layer 302. In this example, the first resist material 304 is not selected based on the waveguide material etch chemistry.

The method 200 may generally include, at operation 206, performing a staircase process for the first segments 312 to form the first segments 312 of the waveguide, the first segments 312 having blazed device structures 106. The blazed device structures 106 may include a plurality of steps, as illustrated. Performing the staircase process for the first segments 312 may include patterning the first resist material 304 to expose an initial portion of the waveguide material in the first segments 312, as illustrated in FIG. 3D. Performing the staircase process may also include removing the initial portion of the first segments 312 to form an initial depth d1 of a plurality of depths, as illustrated in FIG. 3E. Removing the initial portion of the first segments 312 may involve performing a timed etch process to remove the initial portion of the first segments 312. Performing the timed etch process may also remove a layer of the first resist material 304. In some embodiments, when the first resist material 304 is a multi-layer resist, patterning the first resist material 304 may include transferring the pattern from the first resist material 304 to an organic planarization layer (OPL). The OPL may be used as the resist material during patterning.

Performing the staircase process may further include patterning the first resist material 304 to expose a subsequent portion of the waveguide material in the first segments 312, as illustrated in FIG. 3F. Performing the staircase process may also include removing the subsequent portion of the first segments 312 to form a subsequent depth d2 of the plurality of depths in the first segments 312, as illustrated in FIG. 3G. The subsequent depth d2 may be associated with the layer of the first resist material 304 previously removed by the timed etch process. Removing the subsequent portion of the first segments 312 may involve performing the timed etch process to remove the subsequent portion of the first segments 312. The timed etch process may be the same process, or a modified process for each portion of the first segments 312. For example, the duration of the etch process may be modified for different portions of the first segments 312. In some embodiments, the timed etch process includes using a RIE process. Performing the etch process may also remove another layer of the first resist material 304. The staircase process may also include repeating the patterning the first resist material 304 to expose subsequent portions, and removing the subsequent portions to form a final depth d3 of the plurality of depths, as illustrated in FIG. 3H. Removing the subsequent portions of the waveguide material may include using the timed etch process described above.

In some embodiments, a chuck 340 (illustrated in FIGS. 3H and 3M) may used during the method 200 and may be coupled to the waveguide material. The chuck 340 may include one or more electrodes 350. The chuck 340 may also include a vacuum line 360. The chuck 340 may be configured to form a barrier to protect the blazed device structures 106 during processing.

In some embodiments, the timed etch process used during operation 206 may be tuned to form a desired angle for each blazed surface (e.g., blazed surface 108) in the first segments 312 of the waveguide material. During operation 206, the etch selectivity between the waveguide material and the first hardmask layer 302 may be very high, and may therefore limit the removal of material from the second segments 314 of the waveguide material.

In some embodiments, patterning the first resist material 304 to expose the initial portion of the waveguide material in the first segments 312 includes exposing the waveguide material to light of a varying intensity via a lithography process, the varying intensity corresponding to the initial depth d1 to be formed, and developing the first resist material 304 to expose the initial portion of the substrate in the first segments 312. Developing the first resist material 304 may include performing photolithography or digital lithography. Patterning subsequent portions of the waveguide material during the staircase process of operation 206 may be performed in a similar manner.

The method 200 may generally include, at operation 208, removing the first resist material 304, disposing a second hardmask layer 306 over the first segments 312, and removing the first hardmask layer 302, the second hardmask layer 306 exposing second segments 314 of the waveguide material after the first hardmask layer 302 is removed. Removing the first resist material 304 may involve using an etch process, and is illustrated in FIG. 3I. Disposing the second hardmask layer 306 over the first segments 312 may include gap filling the plurality of depths (e.g., including depths d1, d2, d3) with the second hardmask layer 306, and performing a chemical mechanical planarization (CMP) process on the second hardmask layer 306, as illustrated in FIG. 3J. For example, the second hardmask layer 306 may include oxide (SiO) and first hardmask may include Nitride (SiN), and a CMP process polishing oxide stop on Nitride may be used. Removing the first hardmask layer 302 may involve using an etch process, and is illustrated in FIG. 3K.

In some embodiments, the second hardmask layer 306 may be disposed over the waveguide material using one or more PVD, CVD, PECVD, FCVD, ALD, and spin-on processes. In some embodiments, the second hardmask layer 306 includes one or more of Cr, W, WC, Ru, SiN, and SiOₓ, TiN, and C containing materials.

The method 200 may generally include, at operation 210, disposing a second resist material 308 over the second hardmask layer 306 and the waveguide material, as illustrated in FIG. 3L. The second resist material 308 may include a photoresist material. The photoresist material may include light-sensitive polymer containing materials. In some cases, the second resist material 308 is selected based on the waveguide material etch chemistry. In some embodiments, the second resist material 308 may be a single layer resist or a multi-layer resist. For example, the second resist material 308 may be a tri-layer lithography stack (e.g., including an organic planarization layer, a bottom anti-reflection layer and resist), a bi-layer lithography stack (e.g., including a bottom reflection layer+resist, top reflection layer+resist), or other layers. In some embodiments, the second resist material 308 may be a four layer lithography stack. In one example, when the second resist material 308 is a multi-layer resist, patterning the second resist material 308 may include transferring the pattern to the lower layers inside the multi-layer resist before etching the second hardmask layer 306. In this example, the second resist material 308 is not selected based on the second hardmask layer 306 etch chemistry. In some embodiments, the first resist material 304 and the second resist material 308 may include the same materials. In other embodiments, the first resist material 304 and the second resist material 308 may include different materials. In some embodiments, operation 210 is the same as or substantially similar to operation 204, which is described above.

The method 200 may generally include, at operation 212, performing the staircase process for the second segments 314 of the device layer 150, the second segments having second blazed device structures 106. A first blazed device structure of the blazed device structures 106 in the first segments 312 may be adjacent to a first blazed device structure of the blazed device structures 106 in the second segments 314. In some embodiments, operation 212 is the same as or substantially similar to operation 206, which is described above, but applied to the second segments 314 of the waveguide material. Performing the staircase process for the second segments 314 may include patterning the second resist material 308 to expose an initial portion of the waveguide material in the second segments 314, as illustrated in FIG. 3M. Performing the staircase process may also include removing the initial portion of the second segments 314 to form an initial depth of a plurality of depths. Removing the initial portion of the second segments 314 may involve performing a timed etch process to remove the initial portion of the second segments 314 and a layer of the second resist material 308. In some embodiments, when the second resist material 308 is a multi-layer resist, patterning the second resist material 308 may include transferring the pattern from the second resist material 308 to an organic planarization layer (OPL) of the second resist material 308, and the OPL may be used as the resist material during patterning.

Performing the staircase process may further include patterning the second resist material 308 to expose a subsequent portion of the waveguide material in the second segments 314. Performing the staircase process may also include removing the subsequent portion of the second segments 314 to form a subsequent depth of the plurality of depths in the second segments 314. The subsequent depth may be associated with the layer of the second resist material 308 previously removed by the etch process. Removing the subsequent portion of the first segments 312 may involve performing the timed etch process to remove the subsequent portion of the first segments 312 and another layer of the second resist material 308. The staircase process may also include repeating the patterning of the second resist material 308 to expose subsequent portions. The staircase process may further include removing the subsequent portions to form a final depth of a plurality of depths in the second segments 314, as illustrated in FIG. 3N. In some embodiments, the timed etch process used during operation 212 may be tuned to form a desired angle for each blazed surface (e.g., blazed surface 108) in the second segments 314. During operation 212, the etch selectivity between the waveguide material and the second hardmask layer 306 may be very high, and may therefore limit the removal of material from the second segments 314 of the waveguide material. Removing the subsequent portions of the waveguide material may include using the timed etch process described above.

In some embodiments, patterning the second resist material 308 to expose the initial portion of the waveguide material in the second segments 314 includes exposing the waveguide material to light of a varying intensity via a lithography process, the varying intensity corresponding to the initial depth to be formed, and developing the second resist material 308 to expose the initial portion of the substrate in the second segments 314. Developing the first resist material 304 may include performing photolithography or digital lithography. Patterning subsequent portions of the waveguide material during the staircase process of operation 212 may be performed in a similar manner.

The method 200 may optionally include, at operation 214, removing the second hardmask layer 306 and the second resist material 308. The second hardmask layer 306 and the second resist material 308 may each be removed by an etch process.

In some embodiments, operations 202-214 may be used, for example, to form blazed device structures 106 on a device layer 150 disposed on the first surface 118 of the substrate 102. The method 200 may optionally include, at operation 216, repeating at least one of operations 202-214 to form the waveguide 100. After operations 202-214, blazed device structures 106 may also be formed in the device layer 155 disposed on the second surface 119 of the substrate during operation 216. For example, at least one of operations 202-214 may be repeated for first segments 322 and/or second segments 324 of the device layer 155 to form blazed device structures 106 on another surface of a waveguide material, as illustrated in FIG. 1D.

According to certain embodiments, the operation 216 may include patterning the first hardmask layer 302 (which may be referred to as a third hardmask layer) over the device layer 155, the first hardmask layer 302 exposing the first segments 322 of the device layer 155 and being disposed over second segments 324 of the device layer 155 (e.g., similar to operation 202). The first segments 322 of the device layer 155 may correspond to initial blazed device structures 106 to be formed and the second segments 324 of the device layer 155 may correspond to subsequent blazed device structures 106 to be formed. According to certain embodiments, the operation 216 may include disposing the first resist material 304 (which may be referred to as a third resist material) over the first hardmask layer 302 and the device layer 155 (e.g., similar to operation 204), and performing the staircase process for the first segments 322 of the device layer 155, the first segments 322 having blazed device structures 106 (which may be referred to as third blazed device structures) (e.g., similar to operation 206). According to certain embodiments, the operation 216 may include removing the first resist material 304, disposing the second hardmask layer 306 (which may be referred to as a fourth hardmask layer) over the blazed device structures 106, and removing the second hardmask layer 306, the second hardmask layer 306 exposing second segments 324 of the device layer 155 after the second hardmask layer 306 is removed (e.g., similar to operation 208), and disposing the second resist material 304 (which may be referred to as a fourth resist material) over the second hardmask layer 306 and the device layer 155 (e.g., similar to operation 210). According to certain embodiments, the operation 216 may include performing the staircase process for second segments 324 of the device layer 155, the second segments 324 having blazed device structures 106 (which may be referred to as fourth blazed device structures) (e.g., similar to operation 212). The operation 216 may optionally include removing the second hardmask layer 306 and the second resist material 308 (e.g., similar to operation 214).

During operation 216, the chuck 340 (illustrated in FIGS. 3H and 3M) may used may be coupled to the waveguide material and may be configured to form a barrier to protect the blazed device structures 106 during processing. As stated above, the chuck 340 may include one or more electrodes 350. The chuck 340 may also include a vacuum line 360.

Performing the method 200 forms the blazed device structures 106 illustrated in FIGS. 1B, 1C, and/or 1D. The method 200 may enable blazed device structures 106 where the initial depth of the plurality of depths in the first segments 312 is adjacent to a final depth of a plurality of depths in the second segments 314, as illustrated at locations 316, 318, 320 in FIG. 1B. In some embodiments, various operations of the method 200 may be tuned to change the duty cycle used by the method 200. For example, the patterning of the critical dimension (CD) and overly (OVL) used in method 200 may be tuned to change the duty cycle of the method 200, as desired.

In summation, disposing the second hardmask layer 306 over the first segments 312 of the substrate after performing the staircase process on the first segments 312 (e.g., operation 206) and before performing the staircase process on second segments 314 of the waveguide material (e.g., operation 212) enables the fabrication of blazed device structures 106 with sharp tips and corners, as illustrated in FIG. 1B. As a result, the method of fabricating blazed device structures 106 as described herein may eliminate the flat surface often found between adjacent staircases in some blazed device structures, and therefore results in blazed device structures 106 having a greater number of blazed steps, resulting in increased efficiency. According to certain embodiments, the blazed device structures may be fabricated on both sides of the waveguide material to form a double-sided waveguide, such as shown in FIG. 1D.

While the foregoing is directed to embodiments of the present disclosure, other and further embodiments of the disclosure may be devised without departing from the basic scope thereof, and the scope thereof is determined by the claims that follow.

1. A waveguide comprising:
a substrate;
a first device layer disposed over a first surface of the substrate;
a second device layer disposed over a second surface of the substrate; and
a first grating disposed in the first device layer, the first grating comprising a plurality of first blazed device structures arranged in a first direction, each first blazed device structure including:
a plurality of steps;
a facet normal of each of the plurality of steps parallel to a primary surface of the first device layer; and
a blaze angle defined by a blazed surface and the facet normal; and
a second grating disposed in the second device layer, wherein the second grating comprises a plurality of second blazed device structures arranged in a second direction, wherein the second direction is different than the first direction.

2. The waveguide of claim 1, wherein the first surface of the substrate is opposite to the second surface of the substrate and wherein the plurality of the first blazed device structures and the plurality of second blazed device structures are asymmetric.

3. The waveguide of claim 1, wherein the second direction is at an angle to the first direction.

4. The waveguide of claim 2, where each second blazed device structure includes:
a plurality of steps;
a facet normal of each of the plurality of steps of the second blazed device structure parallel to a primary surface of the second device layer; and
a blaze angle defined by a blazed surface and the facet normal.

5. The waveguide of claim 1, wherein the substrate comprises at least one of: glass, lithium niobate (LiNbO3), silicon dioxide (SiO₂), titanium(II) oxide (TiO) fused silica, quartz, or sapphire, and wherein the first device layer and the second device layer each comprise at least one of: titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), or cadmium stannate (Cd₂SnO₄).

6. A method of forming a waveguide, the method comprising:
patterning a first hardmask layer over a first device layer, the first hardmask layer exposing first segments of the first device layer and being disposed over second segments of the first device layer, wherein the first segments of the first device layer correspond to initial blazed device structures to be formed and the second segments of the first device layer correspond to subsequent blazed device structures to be formed;
disposing a first resist material over the first hardmask layer and the first device layer;
performing a staircase process for the first segments of the first device layer to form the first segments of the waveguide, the first segments having first blazed device structures, wherein each of the first blazed device structures include a plurality of steps; and
performing the staircase process for first segments of a second device layer, the first segments of the second device layer having second blazed device structures, wherein each of the second blazed device structures include a plurality of steps, wherein the first device layer is disposed over a first surface of a substrate, wherein the second device layer is disposed over a second surface of the substrate, and wherein the second surface is opposite to the first surface.

7. The method of claim 6, further comprising:
removing the first resist material, disposing a second hardmask layer over the first blazed device structures, and removing the first hardmask layer, the second hardmask layer exposing second segments of the first device layer after the first hardmask layer is removed;
disposing a second resist material over the second hardmask layer and the first device layer; and
performing the staircase process for the second segments of the first device layer, the second segments having third blazed device structures, wherein each of the third blazed device structures include a plurality of steps.

8. The method of claim 7, further comprising:
patterning a third hardmask layer over the second device layer, the third hardmask layer exposing the first segments of the second device layer and being disposed over second segments of the second device layer, and wherein the first segments of the second device layer correspond to initial blazed device structures to be formed and the second segments of the second device layer correspond to subsequent blazed device structures to be formed; and
disposing a third resist material over the third hardmask layer and the second device layer;
removing the third resist material, disposing a fourth hardmask layer over the third blazed device structures, and removing the third hardmask layer, the fourth hardmask layer exposing second segments of the second device layer after the third hardmask layer is removed;
disposing a fourth resist material over the fourth hardmask layer and the second device layer; and
performing the staircase process for second segments of the second device layer, the second segments having fourth blazed device structures, wherein each of the fourth blazed device structures include a plurality of steps, wherein the first blazed device structures and the second blazed device structures are arranged in a first direction and the third blazed device structures and the fourth blazed device structures are arranged in a second direction different than the first direction.

9. The method of claim 8, wherein the second direction is at an angle to the first direction.

10. The method of claim 8, wherein at least one of the first blazed device structures, the second blazed device structures, the third blazed device structures, and the fourth blazed device structures comprises:
a plurality of steps;
a facet normal of each of the plurality of steps parallel to a primary surface of the first device layer or the second device layer; and
a blaze angle defined by a blazed surface and the facet normal.

11. A method of forming a waveguide, the method comprising:
patterning a first hardmask layer over a waveguide material, the first hardmask layer exposing first segments of the waveguide material and being disposed over second segments of the waveguide material, wherein the first segments of the waveguide material correspond to initial blazed device structures to be formed and the second segments of the waveguide material correspond to subsequent blazed device structures to be formed;
disposing a first resist material over the first hardmask layer and the waveguide material;
performing a staircase process for the first segments to form the first segments of the waveguide, the first segments having first blazed device structures;
removing the first resist material, disposing a second hardmask layer over the first blazed device structures, and removing the first hardmask layer, the second hardmask layer exposing second segments of the waveguide material after the first hardmask layer is removed;
disposing a second resist material over the second hardmask layer and the waveguide material; and
performing the staircase process for the second segments, the second segments having second blazed device structures.

12. The method of claim 11, wherein at least one of the first blazed device structures or the second blazed device structures comprises:
a plurality of steps;
a facet normal of each of the plurality of steps parallel to a primary surface of the waveguide material; and
a blaze angle defined by a blazed surface and the facet normal.

13. The method of claim 12, wherein the blazed surface of each of the first blazed device structures and the second blazed device structures include an equal quantity of steps.

14. The method of claim 11, wherein the waveguide material comprises a substrate, and the substrate comprises at least one of: glass, lithium niobate (LiNbO3), silicon dioxide (SiO₂), titanium(II) oxide (TiO) fused silica, quartz, or sapphire.

15. The method of claim 14, wherein the waveguide material comprises a device layer disposed over the substrate, and wherein the device layer comprises at least one of: titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), or cadmium stannate (Cd₂SnO₄).

16. The method of claim 11, wherein the staircase process comprises:
patterning the first resist material to expose an initial portion of the waveguide material in the first segments;
removing the initial portion of the first segments to form an initial depth of a plurality of depths;
patterning the first resist material to expose a subsequent portion of the waveguide material in the first segments;
removing the subsequent portion of the first segments to form a subsequent depth of the plurality of depths in the first segments; and
repeating the patterning of the first resist material to expose subsequent portions and removing the subsequent portions to form a final depth of the plurality of depths.

17. The method of claim 16, wherein the initial depth of the plurality of depths in the first segments is adjacent to a final depth of a plurality of depths in the second segments.

18. The method of claim 16, further comprising:
removing the second hardmask layer and the second resist material.

19. The method of claim 16, wherein disposing the second hardmask layer over the first segments comprises:
gap filling the plurality of depths with the second hardmask layer; and
performing a chemical mechanical planarization (CMP) process.

20. The method of claim 16, wherein patterning the first resist material to expose the initial portion of the waveguide material in the first segments comprises:
exposing the waveguide material to light of a varying intensity via a lithography process, the varying intensity corresponding to the initial depth to be formed; and developing the first resist material to expose the initial portion of the waveguide material in the first segments.
